(19) United States
(12) Patent Application Publication
(10) Pub. No.: US 2004/0167052 A1
(43) Pub. Date: Aug. 26, 2004

(54) Preparation of microbiocidal solutions

(76) Inventor: James M. Sturick, Alpharetta, GA (US)

Correspondence Address: EDGAR SPIELMAN, ALBEMARLE CORPORATION, 451 FLORIDA BLVD., BATON ROUGE, LA, 70801, US

(21) Appl. No.: 10/371,683

(22) Filed: Feb. 21, 2003

(51) Int. Cl. C11D 3/48

(52) U.S. Cl. 510/383

(57) ABSTRACT

A method of forming an aqueous microbiocidal solution, which method comprises: a) situating one or more dibromohydantoin microbiocides in a container which is adapted (i) to receive an aqueous medium introduced therein which contacts the one or more dibromohydantoin microbiocides therein and(ii) to release therefrom an aqueous solution formed therein; b) maintaining said container under a positive pressure, and maintaining an atmosphere of substantially inert gas within the container while aqueous medium is introduced into the container and into contact with the one or more dibromohydantoin microbiocides situated therein; and c) releasing from said container an aqueous solution formed therein.

This invention relates to, and has as its main objective, the provision of a way of preparing highly effective aqueous microbiocidal solutions. Other objectives will appear hereinafter.

Pursuant to this invention, a pressurized feeder system is used to form aqueous solutions of microbiocide having very low solubility in water. The feeder system used operates under positive pressure wherein an inert gas, such as air, nitrogen, or the like, is injected into water which is brought into contact with the microbiocide while both are under a positive pressure within a container. This results in preparation of a solution of the microbiocide. Although it is preferable that the inert gas is injected into water, suitable salts can be present in low concentrations in the water into which the inert gas is injected. Suitable salts which can be present include, for example, sodium chloride, sodium bromide, sodium carbonate, sodium bicarbonate, sodium bisulfate, and/or their lithium or potassium counterparts.

Feeder systems which are used pursuant to this invention and methods of operating such feeders are set forth in detail in U.S. Pat. No. 6,517,727 issued Feb. 11, 2003, all disclosure of which is incorporated herein by reference.

The microbiocides used in the practice of this invention are dibromohydantoins, especially one or more 1,3-dibromo-5,5-dialkylhydantoins in which one of the alkyl groups is a methyl group and the other alkyl group contains in the range of 1 to about 4 carbon atoms. If a mixture of these 1,3-dibromo-5,5-dialkylhydantoins is used, it is preferred to have 1,3-dibromo-5,5-dimethylhydantoin as one of the components of the mixture. A mixture of 1,3-dibromo-5,5-dimethylhydantoin and 1,3-dibromo-5-ethyl-5-methylhydantoin is a preferred mixture. The most preferred microbiocide for use in this invention is 1,3-dibromo-5,5-dimethylhydantoin. This compound is available in the marketplace under the trade designations XtraBrom™ 111 biocide and XtraBrom™ 111 T biocide (Albemarle Corporation). When a mixture of two or more of the foregoing 1,3-dibromo-5,5-dialkylhydantoin biocides is used pursuant to this invention, the individual biocides of the mixture can be in any proportions relative to each other. Minor proportions of mono-N-bromo-5,5-dialkylhydantoin(s) can be present along with the 1,3-dibromo-5,5-dialkylhydantoin(s) but such compositions are less preferred. Process technology which is highly suitable for preparing 1,3-dibromo-5,5-dialkylhydantoins is described in WO 01/53270, published Jul. 26, 2001, all disclosure of which is incorporated herein by reference.

1,3-Dibromo-5,5-dimethylhydantoin as charged to the pressurized feeder system can be in the form of large particles described in U.S. Pat. No. 6,508,954 issued Jan. 21, 2003; in the form of compacted articles formed without use of a binder as described in U.S. Pat. No. 6,448,410 issued Sep. 10, 2002; or in the form of compacted articles formed with use of a binder of the types such as described in WO 01/52651, published Jul. 26, 2001. The entire disclosure of each document referred to in this paragraph is incorporated herein by reference.

As noted above the water solubility of the microbiocide used in the practice of this invention is very low. For example, the solubility of 1,3-dibromo-5,5-dimethylhydantoin in water at 75° F. (ca. 24° C.) is 405 ppm expressed as Cl₂ whereas the solubilities of N,N′-bromochloro-5,5-dimethylhydantoin and of the commercial mixture of N,N-bromochloro-5,5-dimethylhydantoin and 1,3-dichloro-5-ethyl-5-methylhydantoin at the same temperature are, respectively, 890 ppm and 1905 ppm, both expressed as Cl₂. Thus the unification of the 1,3-dibromo-5,5-dimethylhydantoin biocide having very low water solubility with a pressurized feeder system of the type described and operated as in U. S. Pat. No. 6,517,727, is highly advantageous as not only is efficient control of biocidal concentration in the treated water achieved, but in addition, concentrations can be maintained in the water which provide excellent antimicrobial activity. Besides being useful in the treatment of water systems described in U. S. Pat. No. 6,517,727, this invention is especially well suited for microbiocidal treatment of water used in poultry processing such as described in WO 03/001931, published Jan. 9, 2003.

In the practice of this invention, the pressurized feeder system is operated as described in any manner described in U.S. Pat. No. 6,517,727. Without in anyway limiting the generality of the foregoing, the pressurized feeder system can be operated in accordance with each one of the embodiments described in Column 3, line 30 through Column 4 line 10 of U.S. Pat. No. 6,517,727.

That which is claimed is:

1. A method of forming an aqueous microbiocidal solution, which method comprises:
a) situating one or more dibromohydantoin microbiocides in a container which is adapted (i) to receive an aqueous medium introduced therein which contacts the one or more dibromohydantoin microbiocides therein and (ii) to release therefrom an aqueous solution formed therein;
b) maintaining said container under a positive pressure, and maintaining an atmosphere of substantially inert gas within the container while aqueous medium is introduced into the container and into contact with the one or more dibromohydantoin microbiocides situated therein; and
c) releasing from said container an aqueous solution formed therein.

2. A method as in claim 1 wherein said dibromohydantoin is one or more 1,3-dibromo-5,5-dialkylhydantoins in which one of the alkyl groups is methyl and the other is an alkyl group having in the range of one to four carbon atoms.

3. A method as in claim 2 wherein the inert gas is selected from the group consisting of nitrogen, air, oxygen, carbon dioxide, argon, neon, helium and air which is substantially free of carbon-dioxide.

4. A method as in claim 2 wherein inert gas is introduced into the container separate from the aqueous medium.

5. A method as in claim 2 wherein inert gas is aspirated into a conduit connected to the container and then introduced into the container.

6. A method as in claim 5 wherein aqueous medium and inert gas are introduced into the container through the same conduit.

7. A method as in claim 5 wherein air is aspirated into the conduit using an aspirating, differential pressure mixer-injector.

8. A method as in claim 7 wherein the mixer-injector is a Venturi-type differential pressure injector.

9. A method an in any of claims 1-8 wherein aqueous medium is continuously introduced into said container and wherein aqueous solution is continuously released from said container.

10. A method as in any of claims 2-8 wherein said dibromohydantoin is 1,3-dibromo-5,5-dimethylhydantoin.
